(19) United States
(12) Patent Application Publication
(10) Pub. No.: US 2005/0176423 A1
(43) Pub. Date: Aug. 11, 2005

(54) System and method for transmitting data of a mobile terminal

(75) Inventors: Dae-Gyue Park, (US); Hyun-Wook Cho, (US)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/047,767

(22) Filed: Feb. 2, 2005

(30) Foreign Application Priority Data
Feb. 9, 2004 (KR) 2004-8370

(51) Int. Cl. H04Q 7/20

(52) U.S. Cl. 455/428

(57) ABSTRACT

In a system and method for transmitting data of a mobile terminal, a transmitting mobile terminal sends to a server a request for data transmission to a receiving mobile terminal, and is assigned an Internet Protocol (IP) address in response to the request. The receiving mobile terminal receives a message indicating that the transmitting mobile terminal has made the request for data transmission, and a guide message including information of the assigned IP address. Then the receiving mobile terminal accesses the IP address included in the guide message and downloads the data from the transmitting mobile terminal.

### PRIORITY

This application claims the benefit under 35 U.S.C. 119(a) priority to an application entitled “METHOD FOR TRANSMITTING DATA OF A MOBILE TERMINAL”, filed in the Korean Intellectual Property Office on Feb. 9, 2004 and assigned Serial No. 2004-8370, the entire contents of which are incorporated herein by reference.

### BACKGROUND OF THE INVENTION

1. Field of the Invention

The present invention relates generally to a system and method for transmitting data between mobile terminals. More particularly, the present invention relates to a system and method for transmitting data between mobile terminals by which they can exchange the data without using a server of a mobile communication carrier.

2. Description of the Related Art

Generally, mobile terminals can use a Short Messaging Service (SMS) as well as perform a voice communication function. Users can communicate with each other through the mobile terminals. The SMS can transmit up to 80-bytes of text.

Recently, a camera module has been mounted in a mobile terminal. A user can now transmit a multimedia message based on a Multimedia Messaging Service (MMS) including text and images to a mobile terminal of a receiving party.

The MMS uploads text information of the SMS along with image data through a server of a mobile communication carrier. The mobile communication carrier notifies a mobile terminal at a receiving side of the arrival of an MMS message by transmitting an SMS message to a mobile terminal at the receiving side. In this case, a user of a mobile terminal at a transmitting side must pay MMS packet fees to upload the MMS message to the server of the mobile communication carrier.

The mobile terminal at the receiving side downloads the MMS message from the server of the mobile communication carrier. At this point, a user of the mobile terminal at the receiving side must pay information usage fees such as MMS packet fees and pay-per-use fees to download the MMS message.

A conventional method for transmitting an MMS message between mobile terminals will now be described.

FIG. 1 illustrates a conventional method for transmitting an MMS message of a mobile terminal. First, a mobile terminal 1a at a transmitting side uploads, to a server 100 of a mobile communication carrier, the MMS message including image and text data (Image+Text) to be transmitted and phone number information of a mobile terminal 2a at a receiving side.

The mobile communication carrier's server (for data communication) 100 identifies the phone number information of the mobile terminal 2a at the receiving side, and sends, to the mobile terminal 2a, an SMS message indicating that the mobile terminal 1a at the transmitting side has transmitted the MMS message.

When a specific key for accessing a Wireless Application Protocol (WAP) is pressed in the mobile terminal 2a at the receiving side when the SMS message has been received, the MMS message is downloaded from the mobile communication carrier's server 100.

The conventional method for transmitting a multimedia message between mobile terminals is not limited to the MMS, and can be commonly applied when data is exchanged between the mobile terminals. In this case, the data includes text data, image data and audio data as well as MMS data.

However, there is a problem in that the conventional method for transmitting data between mobile terminals must upload corresponding data to the mobile communication carrier's server in order to transmit an MMS message or data to a mobile terminal at a receiving side, and a user of the mobile terminal at the receiving side must pay other information use fees along with packet fees for access to the mobile communication carrier's server.

### SUMMARY OF THE INVENTION

Accordingly, the present invention has been designed to solve the above and other problems occurring in the prior art. Therefore, it is an object of the present invention to provide a system and method for transmitting data of a mobile terminal in which a mobile terminal at a receiving side receives the data without paying information usage fees.

It is another object of the present invention to provide a system and method for transmitting data between terminals in which a mobile terminal at a receiving side accesses an Internet Protocol (IP) address assigned to a mobile terminal at a transmitting side in a technique for uploading/downloading the data through a mobile communication carrier's server when the data is communicated between the mobile terminals.

In accordance with an aspect of the present invention, the above and other objects can be accomplished by a system and method for transmitting data of a mobile terminal. The system and method include, by a mobile terminal at a transmitting side, sending, to a server of a mobile communication carrier, a request for data transmission to a mobile terminal at a receiving side, and being assigned an Internet Protocol (IP) address in response to the request; transmitting, to the mobile terminal at the receiving side, a message indicating that the mobile terminal at the transmitting side has made the request for data transmission, and a guide message including information of the assigned IP address; and accessing the IP address included in the guide message and downloading the data from the mobile terminal at the transmitting side.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates a conventional method for transmitting a Multimedia Messaging Service (MMS) message of a mobile terminal;

FIG. 2 is a block diagram illustrating a mobile terminal in accordance with an embodiment of the present invention;

FIG. 3 is a flow chart illustrating a method for transmitting data in accordance with an embodiment of the present invention;

FIG. 4 illustrates a guide message transmitted to a mobile terminal at a receiving side in accordance with an embodiment of the present invention;

FIG. 5 is a flow chart illustrating a method for transmitting data in accordance with another embodiment of the present invention; and

FIG. 6 illustrates a method for transmitting data between mobile terminals at transmitting and receiving sides in accordance with an embodiment of the present invention.

### DETAILED DESCRIPTION OF THE PREFERRED EMBODIMENTS

Embodiments of the present invention will be described in detail herein below with reference to the accompanying drawings.

In the following description, a detailed description of known functions and configurations incorporated herein will be omitted for conciseness.

In the following description, a mobile communication carrier's server assigns a general Internet Protocol (IP) address and functions as a Short Messaging Service (SMS) center. Additionally, in the following description, a guide message is a message transmitted to a mobile terminal at a receiving side by the mobile communication carrier's server when a mobile terminal at a transmitting side generates data to be transmitted and is assigned an IP address. For example, the guide message is defined as an SMS message.

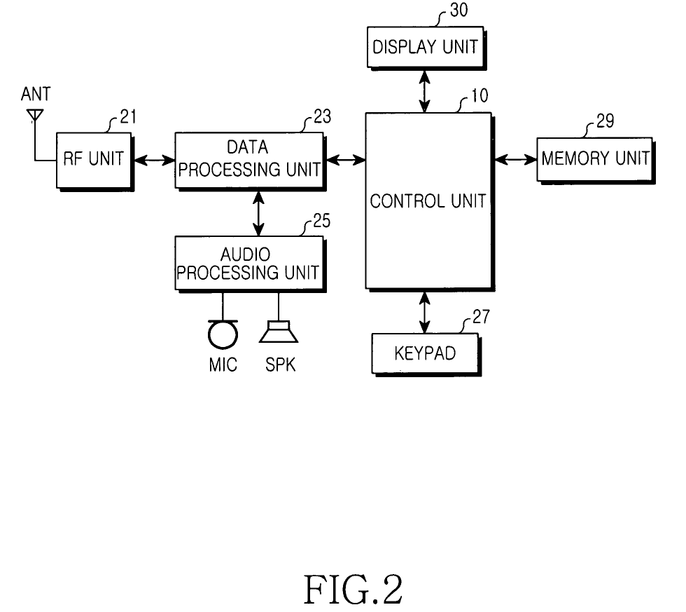

FIG. 2 is a block diagram illustrating a mobile terminal in accordance with an embodiment of the present invention.

Referring to FIG. 2, a Radio Frequency (RF) unit 21 performs a communication function. The RF unit 21 includes a RF transmitter (not shown) for up-converting and amplifying a frequency of a signal to be transmitted and a RF receiver (not shown) for low-noise amplifying a received signal and down-converting a frequency of the received signal.

A data processing unit 23 includes a transmitter (not shown) for coding and modulating the signal to be transmitted and a receiver (not shown) for demodulating and decoding the received signal. That is, the data processing unit 23 can comprise a modulator-demodulator (MODEM) and a coder-decoder (CODEC).

An audio processing unit 25 performs a function for reproducing a received audio signal output from the data processing unit 23 or outputting a transmission audio signal generated from a microphone (MIC) to the data processing unit 23. Moreover, the audio processing unit 25 converts voice data among data received from the data processing unit 23 into audible sound, and then outputs the audible sound through a speaker (SPK). Further, the audio processing unit 25 converts an input voice signal into data, and then outputs the data to the data processing unit 23.

A keypad 27 includes keys necessary for inputting numbers and letter information and function keys necessary for setting various functions. More specifically, the keypad 27 can include a data SEND key, an OK key, an END key, etc. in accordance with the embodiment of the present invention.

A memory unit 29 can comprise program and data memories, etc. The program memory can store programs for controlling general operation of the mobile terminal. More specifically, the memory unit 29 stores a program for requesting that the mobile communication carrier's server assign an IP address, and transmitting data to the mobile terminal at the receiving side by means of the assigned IP address and a port number set, in advance, via a negotiation when the data SEND key provided in the keypad 27 of the mobile terminal at the transmitting side is input in accordance with the embodiment of the present invention. The data memory performs a function for temporarily storing data generated while the programs are executed.

A control unit 10 performs a function for controlling the overall operation of the mobile terminal. Alternatively, the control unit 110 can include the data processing unit 23. More specifically, the control unit 10 controls the mobile terminal to access the IP address assigned by the mobile communication carrier's server in response to the input of the data SEND key in accordance with the embodiment of the present invention. Further, the control unit 10 controls overall operations such that the mobile terminals at the transmitting and receiving sides access the identical IP address to exchange data in accordance with the embodiment of the present invention.

A display unit 30 displays messages generated while programs are executed under control of the control unit 10. More specifically, the display unit 30 displays a guide message received from the mobile communication carrier's server under control of the control unit 10 in accordance with the embodiment of the present invention. Further, the display unit 30 displays on the mobile terminal at the transmitting side an amount of transmitted data, and displays on the mobile terminal at the receiving side an amount of received data. Here, the display unit 160 can be a Liquid Crystal Display (LCD). For a LCD, the display unit 30 can include a LCD controller, a memory capable of storing picture data, a LCD element, etc. When the LCD is implemented using a touch-screen system, the keypad 27 and the LCD can serve as an input unit.

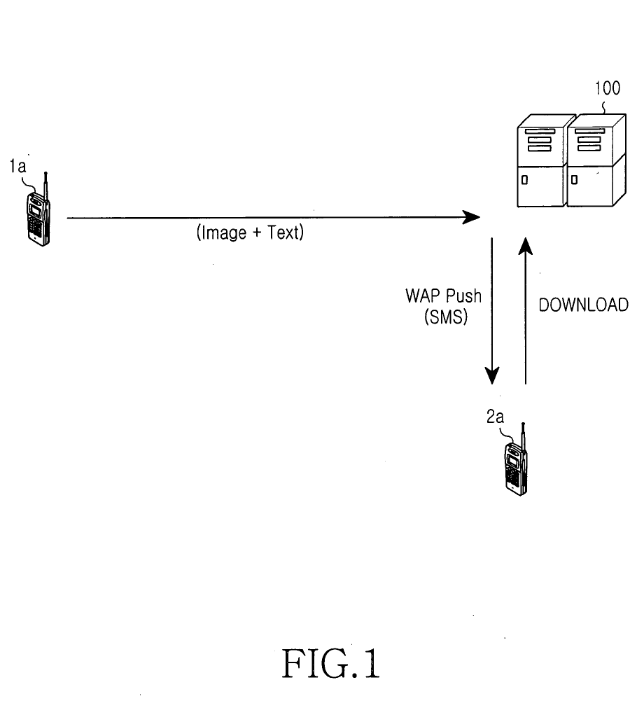

Operation of the mobile terminal will be described with reference to FIG. 1. When a user sets a signal transmission mode after performing a dialing operation through the key input unit 27, the control unit 10 detects the set signal transmission mode, controls the data processing unit 23 to process received dial information, and controls the RF unit 21 to convert the processed information into an RF signal and output the RF signal. Subsequently, when a receiving subscriber generates a response signal, the control unit 10 detects the response signal through the RF unit 21 and the data processing unit 23. The user performs a communication function by means of a voice communication path established through the audio processing unit 25. On the other hand, when a signal reception mode is performed, the control unit 10 detects the signal reception mode through the data processing unit 23 and controls the audio processing unit 25 to generate a ringtone. Subsequently, when the user makes a response, the control unit 10 detects the response. The user performs a communication function by means of a voice communication path established through the audio processing unit 25. Although an example of voice communication in the signal transmission and reception modes has been described above, a data communication function for communicating packet data and image data other than the voice communication can be performed. When an idle mode or character or text communication is entered/performed, the control unit 10 controls the display unit 30 to display character or text data processed by the data processing unit 23.

Operation of the mobile terminal constructed as mentioned above when data is processed and transmitted will now be described.

First, a mobile terminal for transmitting data is referred to as a mobile terminal at a transmitting side, and a mobile terminal for receiving the data is referred to as a mobile terminal at a receiving side.

When the data SEND key or a specific key with the same function as that of the data SEND key is input, the control unit 10 of the mobile terminal at the transmitting side recognizes the key input and requests that the mobile communication carrier's server assign an IP address. The control unit 10 of the mobile terminal at the transmitting side controls the mobile terminal to access the IP address assigned by the mobile communication carrier's server. At this point, the mobile terminal at the receiving side receives, from the mobile communication carrier's server, a guide message indicating that the mobile terminal at the transmitting side has made the request for data transmission. The control unit 10 of the mobile terminal at the receiving side controls the display unit 30 to display the guide message. Subsequently, when the OK key or a specific key with the same function as that of the OK key is input, the control unit 10 of the mobile terminal at the receiving side accesses the identical IP address to receive data from the mobile terminal at the transmitting side.

That is, the mobile terminal at the transmitting side acts as a pre-existing mobile communication server (or a data communication server), such that data can be communicated between the terminals.

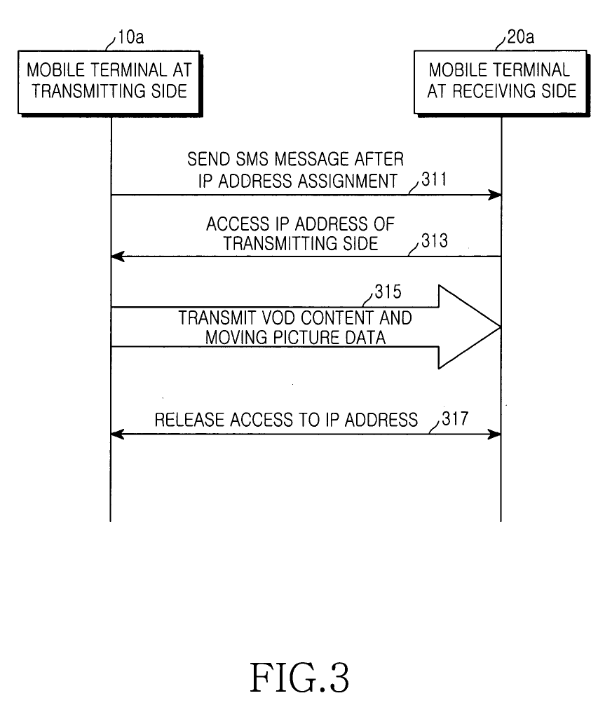

FIG. 3 illustrates a process for transmitting data between the mobile terminals at the transmitting and receiving sides.

In step 311, the mobile terminal 10a at the transmitting side is assigned an IP address from the mobile communication carrier's server, and then transmits an SMS guide message to the mobile terminal 20a at the receiving side. Here, the guide message is transmitted to the mobile terminal 20a by the mobile communication carrier's server at the same time that the IP address is assigned to the mobile terminal 10a at the transmitting side. After a user of the mobile terminal 10a is assigned the IP address, the mobile terminal 20a can be notified of the SMS message.

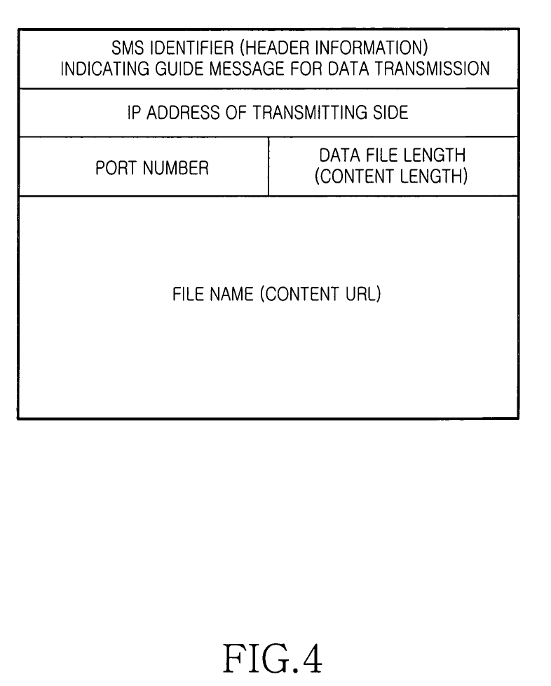

As illustrated in FIG. 4, the SMS message includes header information indicating a guide message for data transmission, information of an IP address that the mobile terminal at the transmitting side is assigned, information on a port number designated by a specific server program of the mobile communication carrier, information of the length of a data file to be transmitted (or content length), and filename (or content Uniform Resource Locator (URL)) information. Here, the port number and the file length information comprise 16 bits, respectively. Other information comprises 32 bits.

Referring again to FIG. 3, the mobile terminal 20a at the receiving side accesses the IP address and the port number of the mobile terminal 10a at the transmitting side included in the SMS message in step 313, and receives Video On Demand (VOD) data, moving picture data, and so on from the mobile terminal 10a at the transmitting side in step 315.

Subsequently, when any one of the mobile terminal 10a at the transmitting side and the mobile terminal 20a at the receiving side releases access to the IP address, the process for transmitting VOD content and moving picture data is terminated in step 317.

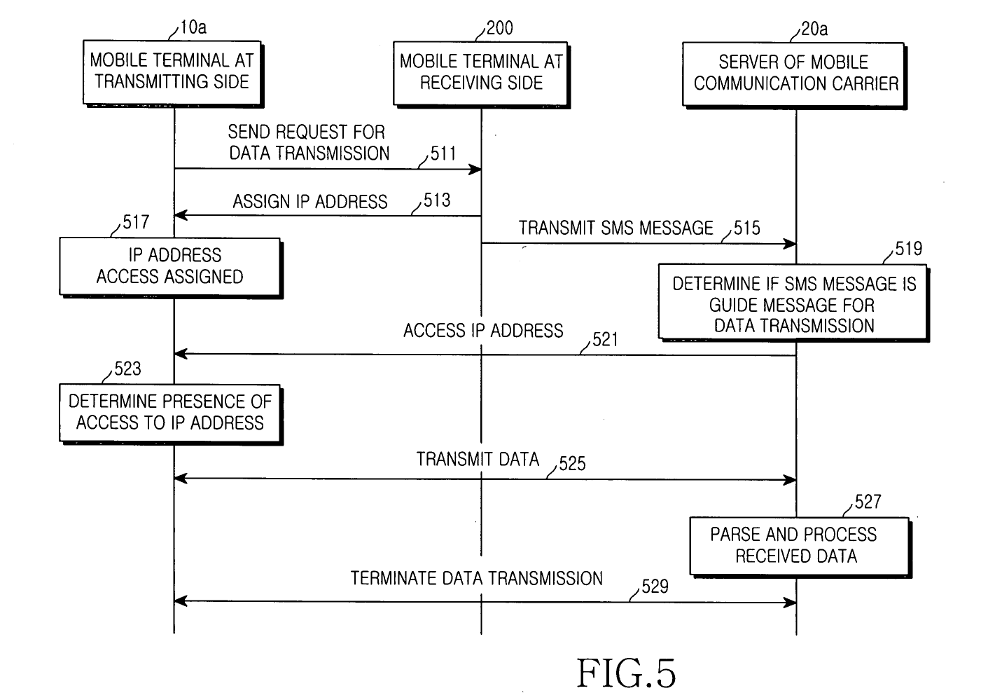

FIG. 5 is a flow chart illustrating the method for transmitting data of the mobile terminal in accordance with another embodiment of the present invention.

Referring to FIG. 5, the mobile terminal 10a at the transmitting side sends a request for data transmission to the mobile communication carrier's server 200 responsible for IP address assignment in step 511. That is, the data SEND key provided in the keypad 27 of the mobile terminal 10a is input.

In step 513, the mobile communication carrier's server 200 assigns an IP address in response to the request for data transmission from the mobile terminal 10a at the transmitting side. Because the process of assigning the IP address is a well-known technique, description of the assignment process is omitted.

In step 515, the mobile communication carrier's server 200 transmits a guide message based on SMS to the mobile terminal 20a to receive the data from the mobile terminal 10a at the transmitting side. The format of the SMS message is the same as illustrated in FIG. 4.

In step 517, the mobile terminal 10a at the transmitting side accesses the assigned IP address and waits for the mobile terminal 20a at the receiving side to connect.

In step 519, the mobile terminal 20a at the receiving side receiving the SMS message determines if the received SMS message is a guide message for data transmission from the mobile terminal 10a at the transmitting side. The mobile terminal 20a makes the determination by means of header information indicating the guide message for data transmission among information of the received SMS message.

If the header information of the received SMS message does not indicate a guide message for data transmission as a result of the determination by the mobile terminal 20a at the receiving side, it is determined that the received SMS message is a general SMS message.

However, if the header information indicates the guide message for data transmission as a result of the determination by the mobile terminal 20a at the receiving side, flow proceeds to step 521. The mobile terminal 20a connects by means of a port number and IP address information included in the received SMS message.

In step 523, the mobile terminal 10a at the transmitting side determines if the mobile terminal 20a at the receiving side has accessed the IP address.

If the mobile terminal 20a at the receiving side has accessed the IP address, the mobile terminal 10a at the transmitting side acting as a server transmits, to the mobile terminal 20a, data corresponding to data filename information included in the SMS message in step 525.

In step 527, the mobile terminal 20a at the receiving side parses and processes the received data by means of data file length information included in the SMS message.

Subsequently, in step 529, if the mobile terminal 20a at the receiving side has completely received data or the mobile terminal 10a at the transmitting side has completely transmitted data, the mobile terminal 10a terminates the data transmission to the mobile terminal 20a. Even when the END key of the keypad 27 is input in any one of the mobile terminals 10a and 20a, the data transmission is terminated.

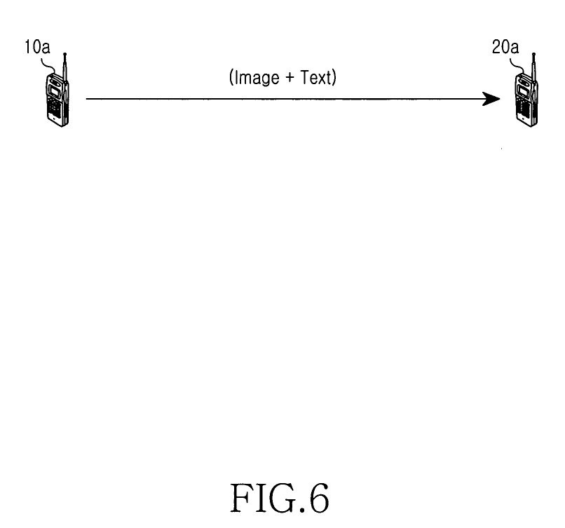

Accordingly, the method for transmitting data of the mobile terminal does not use the mobile communication carrier's server for data communication while the data is transmitted as illustrated in FIG. 6. As illustrated in FIG. 6, it can be seen that data (Image+Text) is transmitted between the mobile terminal 10a at the transmitting side and the mobile terminal 20a at the receiving side through an IP address assigned from the mobile communication carrier's server.

As apparent from the above description of the present invention, a mobile terminal at a receiving side accesses the same IP address and the same port number as in an SMS guide message including information such as an IP address and a port number of a mobile terminal at a transmitting side assigned from a server of a mobile communication carrier. Because the mobile terminal at the transmitting side acts as a server, data can be exchanged between the terminals. Accordingly, a user of the mobile terminal at the receiving side can eliminate the economic burden due to information use fees.

Although certain embodiments of the present invention have been disclosed for illustrative purposes, those skilled in the art will appreciate that various modifications, additions and substitutions are possible, without departing from the scope of the present invention. Therefore, the present invention is not limited to the above-described embodiments, but is defined by the following claims, along with their full scope of equivalents.

1. A method for transmitting data between a transmitting mobile terminal and a receiving mobile terminal, comprising:
transmitting from the transmitting mobile terminal to a server, a request for data transmission to the receiving mobile terminal and being assigned an Internet Protocol (IP) address in response to the request;
transmitting, to the receiving mobile terminal, a message indicating that the transmitting mobile terminal has made the request for data transmission, and a guide message including information of the assigned IP address; and
accessing the IP address included in the guide message and downloading the data from the transmitting mobile terminal.

2. The method of claim 1, wherein the downloading comprises:
determining if the receiving mobile terminal has completely downloaded the data; and
releasing via the transmitting mobile terminal a connection with the IP address along with the receiving mobile terminal if the receiving mobile terminal has completely downloaded the data.

3. The method of claim 1, wherein the guide message comprises a Short Messaging Service (SMS) message.

4. The method of claim 1, wherein the guide message comprises:
header information indicating the guide message for data transmission;
the information of the IP address that the transmitting mobile terminal is assigned;
information on a port number designated by a specific server program of a mobile communication carrier; and
filename information of the data to be transmitted.

5. The method of claim 4, wherein the guide message further comprises:
size information of the data.

6. The method of claim 1, wherein the data to be transmitted comprises at least one of text messages and image content.

7. The method of claim 6, wherein the image content comprises at least one of video on demand content and still image content.

8. A system for directly communicating data between a transmitting mobile Terminal and a receiving terminal, comprising:
the transmitting mobile terminal being adapted to transmit to a server, a request for data transmission to the receiving mobile terminal and being assigned an Internet Protocol (IP) address in response to the request, and transmit to the receiving mobile terminal a message indicating that the transmitting mobile terminal has made the request for data transmission, and a guide message including information of the assigned IP address; and
the receiving mobile terminal being adapted to access the IP address included in the guide message and download the data from the transmitting mobile terminal.

9. The system of claim 8, wherein the transmitting mobile terminal is further adapted to determine if the receiving mobile terminal has completely downloaded the data, and release via the transmitting mobile terminal a connection with the IP address along with the receiving mobile terminal if the receiving mobile terminal has completely downloaded the data.

10. The system of claim 8, wherein the guide message comprises a Short Messaging Service (SMS) message.

11. The system of claim 8, wherein the guide message comprises:
header information indicating the guide message is for data transmission;
the IP address that the transmitting mobile terminal is assigned;
information on a port number designated by a specific server program of a mobile communication carrier; and
filename information of the data to be transmitted.

12. The system of claim 11, wherein the guide message further comprises:
size information of the data.

13. The system of claim 8, wherein the data to be transmitted comprises at least one of text messages and image content.

14. The system of claim 13, wherein the image content comprises at least one of video on demand content and still image content.
